(19) United States
(12) Patent Application Publication
(10) Pub. No.: US 2021/0133667 A1
(43) Pub. Date: May 6, 2021

(54) SYSTEMS AND METHODS FOR PROCESSING ONLINE PRODUCT ORDERS

(71) Applicant: Walmart Apollo, LLC, Bentonville, AR (US)

(72) Inventors: Austin J. Wood, Chicago, IL (US); Matthew M. Morelock, Chicago, IL (US); Brynn C. Aljoe, Chicago, IL (US)

(21) Appl. No.: 17/091,376

(22) Filed: Nov. 6, 2020

Related U.S. Application Data
(60) Provisional application No. 62/931,661, filed on Nov. 6, 2019.

(51) Int. Cl. G06Q 10/08

(52) U.S. Cl. CPC G06Q 10/087

(57) ABSTRACT

In some embodiments, apparatuses and methods are provided herein useful to processing online product orders. In some embodiments, there is provided a system for processing online product orders includes a plurality of picking stations; a plurality of consolidating stations; a plurality of packing stations; and a control circuit configured to assign an online order to at least one picking station after checking that the online order will not cause at least one picking station to exceed a picking capacity limit; assign, in the event consolidation is needed, the online order to at least one consolidating station after checking that the online order will not cause at least one consolidating station to exceed a consolidating capacity limit; and assign the online order to at least one packing station after checking that the online order will not cause the at least one packing station to exceed a packing capacity limit.

### CROSS-REFERENCE TO RELATED APPLICATION

This application claims the benefit of U.S. Provisional Application No. 62/931,661 filed Nov. 6, 2019, which is incorporated herein by reference in its entirety.

### TECHNICAL FIELD

This invention relates generally to processing online product orders.

### BACKGROUND

Generally, when a customer submits a retail order, a fulfillment facility of a retail store receives the retail order. An associate of the fulfillment facility picks one or more products associated with the retail order from an inventory location of the fulfillment facility. The associate will then pack the one or more products for delivery to the customer.

### BRIEF DESCRIPTION OF THE DRAWINGS

Disclosed herein are embodiments of systems, apparatuses and methods pertaining to processing online product orders at a fulfillment facility. This description includes drawings, wherein:

FIG. 1 illustrates a simplified block diagram of an exemplary system for processing online product orders at a fulfillment facility in accordance with some embodiments;

FIGS. 2A-2B shows a flow diagram of an exemplary process of processing online product orders at a fulfillment facility in accordance with some embodiments;

FIGS. 3A-3R shows a flow diagram of an exemplary process of processing online product orders at a fulfillment facility in accordance with some embodiments;

FIG. 4 illustrates an exemplary system for use in implementing methods, techniques, devices, apparatuses, systems, servers, sources and processing online product orders at a fulfillment facility in accordance with some embodiments;

FIG. 5 shows a flow diagram of an exemplary process of processing online product orders at a fulfillment facility in accordance with some embodiments;

FIG. 6 illustrates a simplified block diagram of an exemplary system for processing online product orders at a fulfillment facility in accordance with some embodiments; and

FIG. 7 illustrates exemplary capacity limits for processing online product orders at a fulfillment facility in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for processing online product orders at a fulfillment facility. In some embodiments, a system for processing online product orders at a fulfillment facility includes a plurality of picking stations. By one approach, each picking station may provide a process of picking units from online orders. In one example, each of the plurality of picking stations may have a picking capacity limit associated therewith. In such an example, the picking capacity limit may define a maximum number of units to be assigned to be picked by the picking station. Alternatively or in addition to, the system may include the plurality of consolidating stations. In one example, each consolidating station may provide a process of consolidating multiple picked units from the online orders for packing. By one approach, each of the plurality of consolidating stations may have a consolidating capacity limit associated therewith. In one configuration, the consolidating capacity limit may define a maximum number of units to be assigned to be consolidated by the consolidating stations. Alternatively or in addition to, the system may include the plurality of packing stations. By one approach, each packing station may provide a process of packing picked units and/or packing consolidated picked units into packing containers in accordance with the online orders. For example, each of the plurality of packing stations may have a packing capacity limit associated therewith. In one configuration, the packing capacity limit may define a maximum number of units to be assigned to be packed by the packing station. Alternatively or in addition to, the system may include the control circuit coupled to the plurality of picking stations, the plurality of consolidating stations, and/or the plurality of packing stations. By one approach, the control circuit may, for each received online order, assign the received online order to at least one picking station after checking that the received online order will not cause the at least one picking station to exceed the picking capacity limit. In one configuration, the control circuit may assign, in the event consolidation is needed, the received online order to at least one consolidating station after checking that the received online order will not cause the at least one consolidating station to exceed the consolidating capacity limit. Alternatively or in addition to, the control circuit may assign the received online order to at least one packing station after checking that the received online order will not cause the at least one packing station to exceed the packing capacity limit.

In some embodiments, a method for processing online product orders at a fulfillment facility includes, for each received online order, assigning the received online order to at least one picking station after checking that the received online order will not cause the at least one picking station to exceed the picking capacity limit. In one configuration, the method may include assigning, in the event consolidation is needed, the received online order to at least one consolidating station after checking that the received online order will not cause the at least one consolidating station to exceed the consolidating capacity limit. Alternatively or in addition to, the method may include assigning the received online order to at least one packing station after checking that the received online order will not cause the at least one packing station to exceed the packing capacity limit.

In some embodiments, a system for processing online product orders at a fulfillment facility may include a plurality of picking stations. By one approach, each picking station may provide a process of picking units from online orders. In one configuration, each of the plurality of picking stations may have a picking capacity limit associated therewith. For example, the picking capacity limit may define a maximum number of units to be assigned to be picked by the picking station. By another approach, the system may include the plurality of consolidating stations. In one configuration, each consolidating station may provide a process of consolidating multiple picked units from the online orders for packing. For example, each of the plurality of consolidating stations may have a consolidating capacity limit associated therewith. In one scenario, the consolidating capacity limit may define a maximum number of units to be assigned to be consolidated by the consolidating station. By another approach, the system may include the plurality of packing stations. In one configuration, each packing station may provide a process of packing picked units and packing consolidated picked units into packing containers in accordance with the online orders. For example, each of the plurality of packing stations may have a packing capacity limit associated therewith. In some implementations, the packing capacity limit may define a maximum number of units to be assigned to be packed by the packing station.

In some implementations, the system may include the control circuit coupled to the plurality of picking stations, the plurality of consolidating stations, and/or the plurality of packing stations. By one approach, the control circuit may, for each received online order, determine a respective picking station to assign to the received online order by evaluating picking stations in priority order until a highest priority picking station that would not exceed its picking capacity limit if assigned is found. Alternatively or in addition to, the control circuit may determine, in the event consolidation is needed, a respective consolidating station to assign to the received online order by evaluating consolidating stations in priority order until a highest priority consolidating station that would not exceed its consolidating capacity limit if assigned is found. Alternatively or in addition to, the control circuit may determine a respective packing station to assign to the received online order by evaluating packing stations in priority order until a highest priority packing station that would not exceed its packing capacity limit if assigned is found. Alternatively or in addition to, the control circuit may assign the received online order to the respective picking station, the respective consolidating station in the event consolidation is needed, and/or the respective packing station

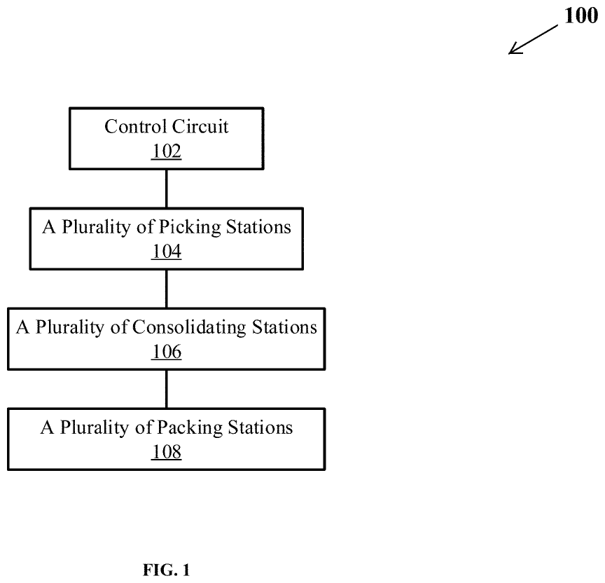

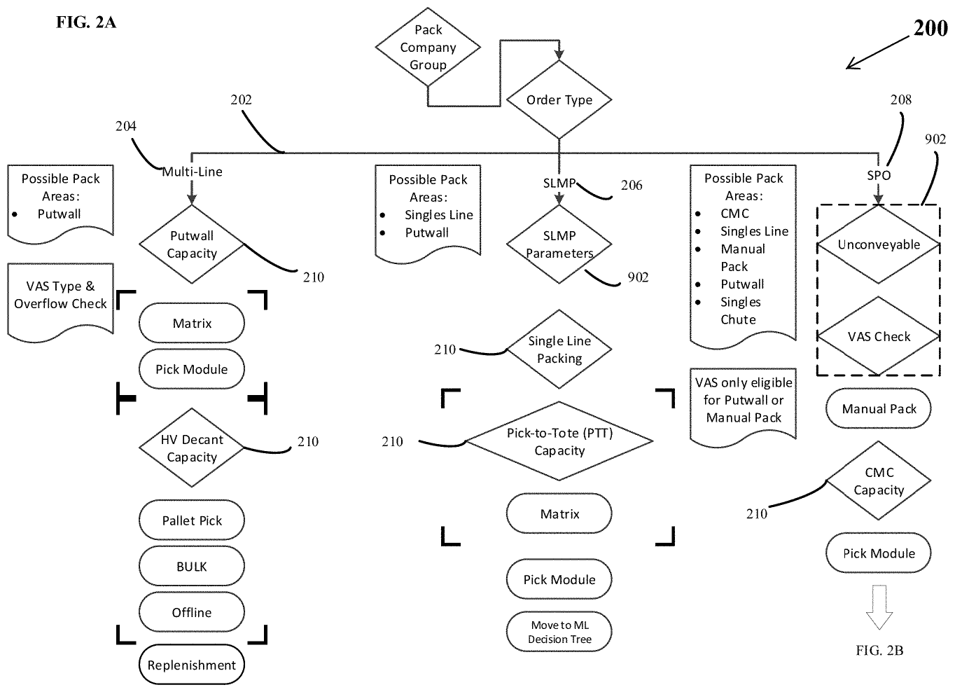

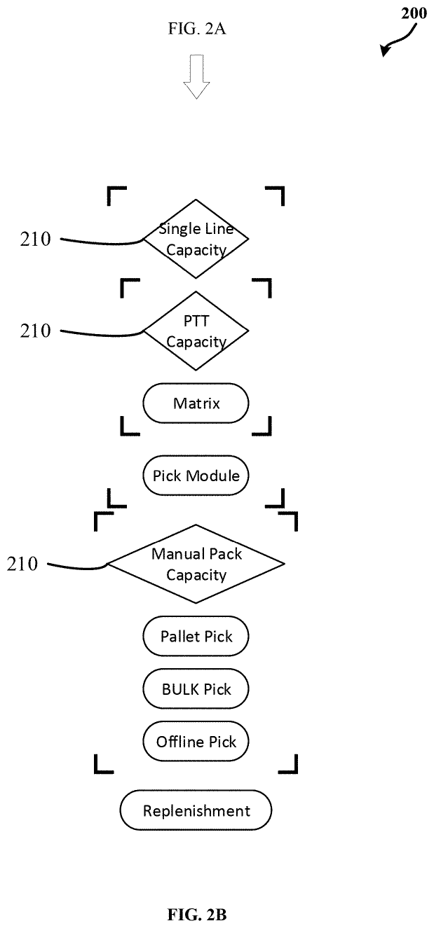

To illustrate some embodiments, FIGS. 1-7 are described below. FIG. 1 illustrates a simplified block diagram of an exemplary system 100 for processing online product orders at a fulfillment facility in accordance with some embodiments. The system 100 includes a control circuit 102. By one approach, the control circuit 102 may be associated with the fulfillment facility. By another approach, the control circuit 102 may be associated with one or more fulfillment facilities. By another approach, the control circuit 102 may include a server, a computer, a computer processor a distributed computing system, to name a few. By some implementations, the control circuit 102 may couple and/or control sensor, conveyors, sorting devices, packing machines, and/or labeling machines used for picking, consolidating, and/or packing units associated with an online order. In one configuration, the control circuit 102 may be coupled to a database (not shown). In some implementations, the database may store a plurality of associations between inventory units available in the fulfillment facility with a plurality of picking stations 104. Alternatively or in addition to, the database may include associations of picked unit of the inventory with a plurality of consolidating stations 106. Alternatively or in addition to, the database may include associations of consolidated picked units with a plurality of packing stations 108. In an illustrative non-limiting example, the components of FIG. 1 are further described in FIGS. 2A-2B. For example, the control circuit 102 may execute one or more steps in the method 200. FIGS. 2A-2B show a flow diagram of an exemplary process/method 200 of processing online product orders at a fulfillment facility in accordance with some embodiments. The method 200 includes receiving an online order from one of a plurality of pack company groups. In one configuration, the online order may be associated with an order type. By one approach, the order type may include a multi-line/item order (ML), a single line/item multi-piece order (SLMP), and/or a single piece order (SP). For example, the ML order may include two or more unit of items. In such an example, an item may correspond to a particular product. Another example, the SLMP order may include multiple quantity/units ordered for the same item. In yet another example, the SP order may include a single quantity ordered item.

By one approach, an ML order type 204 may only be associated with a putwall pack area and/or a high velocity decant pack area. By one configuration, the method 200 may include determining whether one or more putwall pack areas and/or the high velocity decant pack areas are still within a packing capacity limit. For example, the control circuit 102 may determine whether at least one shelf/cubby storage/consolidating storage area of the one or more putwall pack areas is available to store and/or stage multiple picked units of items for online orders until all units of items associated with the given online orders are picked and/or staged in the shelf/cubby storage/consolidating storage area. In one scenario, the consolidating storage area may include a shelf By another configuration, the plurality of picking stations 104 may include a matrix picking area (or an automated source retrieval system), a pick module picking area (or a manual retrieval system), a pallet pick area, a bulk items pick area, an offline pick area, and/or a replenishment picking area. For example, the system 100 may include the automated source retrieval system including one or more robots configured to pick units from at least one of the plurality of picking stations and place the picked units on at least one of a conveyor, a cart, and a tote to hold the picked units in place while being transported to at least one of the plurality of consolidating stations and the plurality of packing stations.

By one approach, a picking station/area may include inventory units of items that are stored and/or retrieved in a particular way. For example, the matrix picking area may store and/or retrieve inventory units of items automatically and/or with a robot and/or drone's assistance and/or transported to one or more of the plurality of consolidating stations 106 and/or one or more of the plurality of packing stations 108 via a conveyor system. In such an example, the conveyor system may include a mechanical handling equipment that moves units of items/materials/products from one location to another in the fulfillment facility. In one configuration, the system 100 may include conveyors configured to convey units between one or more of the plurality of picking stations 104, one or more of the consolidating stations 106, and/or one or more of the packing stations 108. In another example, the pick module picking area may store and/or retrieve inventory units of items manually and/or transport the retrieved and/or picked inventory units of items to one or more of the plurality of consolidating stations 106 and/or one or more of the plurality of packing stations 108 via a conveyor system. In yet another example, the replenishment picking area may include inventory units of items that are set aside and/or reserved and/or may be stored in a plurality of pallets. In such an example, the system 100 may only retrieve inventory units of items from the replenishment picking area upon a determination that a quantity of a particular item associated with an online order cannot be satisfied from the other previously described picking area. In some implementations, an order type that is associated with a value added service (e.g., gift wrapping requested by the customer, a promotional item included in the consolidated picked item, Hazmat, and/or the like) may only be consolidated and/or packed in the one or more putwall pack area and/or the high velocity decant pack area.

By another approach, the order type may be associated with the SLMP order 206. In some configurations, the method 200 may include receiving an SLMP parameters that determines and/or used to determine whether the items and/or the corresponding units associated with the online order is packable in a single line packing area and/or a putwall packing area. In one scenario, the control circuit 102 may determine whether the units of item(s) in the online order can be placed inside a tote, as shown in the pick-to-tote capacity of method 200. In response to the determination that the units of item(s) can be placed inside a tote, the method 200 may include picking the units of item(s) from the matrix picking area and/or the pick module picking area.

By another approach, the order type may be associated with the SP order 208. In some implementations, the method 200 may determine whether the item is unconveyable and/or un-transportable via a conveyor system. In one configuration, the control circuit 102 may determine, based on the determination on whether the item is unconveyable and/or un-transportable via the conveyor system and/or a determination on whether the item is associated with a value added service, to pack the item in at least one of the packing areas (e.g., a CMC packing area, a single line packing area, a manual packing area, a putwall packing area, and/or a single chute packing area). In one scenario, the CMC packing area may correspond to a fully and/or partially automated packing area comprising a machine capable of packing one or more items in a box ready for a delivery to a customer. In one configuration, the method 200 may include in response to determining that the item is associated with value added service, the control circuit 102 may determine that the item is eligible and/or designated to be pack in the putwall packing area and/or the manual packing area. Alternatively or in addition to, the control circuit 102 may further determine that the item cannot be pack in the putwall packing area based at least on one of the size of the item, contents of the item, and/or the type of the item. Alternatively or in addition to, the control circuit 102 may determine that the item is capable of being packed in the CMC packing area and/or, in response, determine to pick the item from the pick module picking area. By one approach, the control circuit may, in response to a determination that the item may be capable of being packed in a single line packing area and/or being placed inside a tote, pick the item from the matrix picking area.

Alternatively or in addition to, the control circuit 102 may, in response to a determination that the item may not be picked from the matrix picking area and/or cannot be placed inside the tote, pick the item from the pick module picking area. Alternatively or in addition to, the control circuit 102 may determine that the item may not be conveyable via the conveyor system and/or not available in the matrix picking area and/or the pick module picking area. In response, the control circuit 102 may pick the item from at least one of pallet pick area, a bulk items pick area, and/or an offline pick area. By one approach, in response to picking the item from at least one of pallet pick area, a bulk items pick area, and/or an offline pick area, an associate may transport the item to a consolidation area and/or a packing area. In yet another implementations, in response to a determination that the item may not be pick and/or is unavailable to be picked from the matrix picking area, the pick module picking area, the pallet pick area, a bulk items pick area, and/or an offline pick area, the control circuit 102 may pick the item from the replenishment picking area.

In some embodiments, the control circuit 102 may determine that processing and/or fulfilling a batch of online orders is taking longer than expected and/or a predetermined time. In some embodiments, the control circuit 102 may determine that one or more online orders in the batch are causing the stalling of continuous processing of batched orders. In response, the control circuit 102 may cause the processing and/or fulfillment of the batch of online orders to stop and initiate a new batch of online orders. In some embodiments, the new batch of online orders may include a portion of the stopped batch online orders or the entire remaining unprocessed orders from the stopped batch online orders. In yet some embodiments, the control circuit 102 may determine which one or more of the online orders in the batch are stalling. In response, the control circuit 102 may initiate a new batch of online orders that does not include the one or more of the online orders that caused the stalling and/or longer processing of the previous batch.

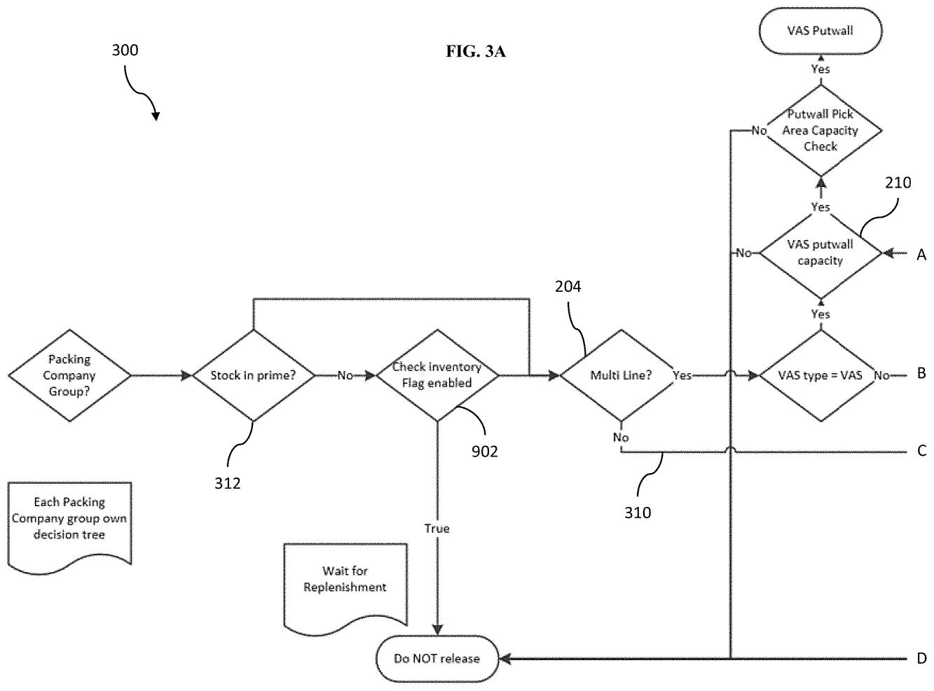

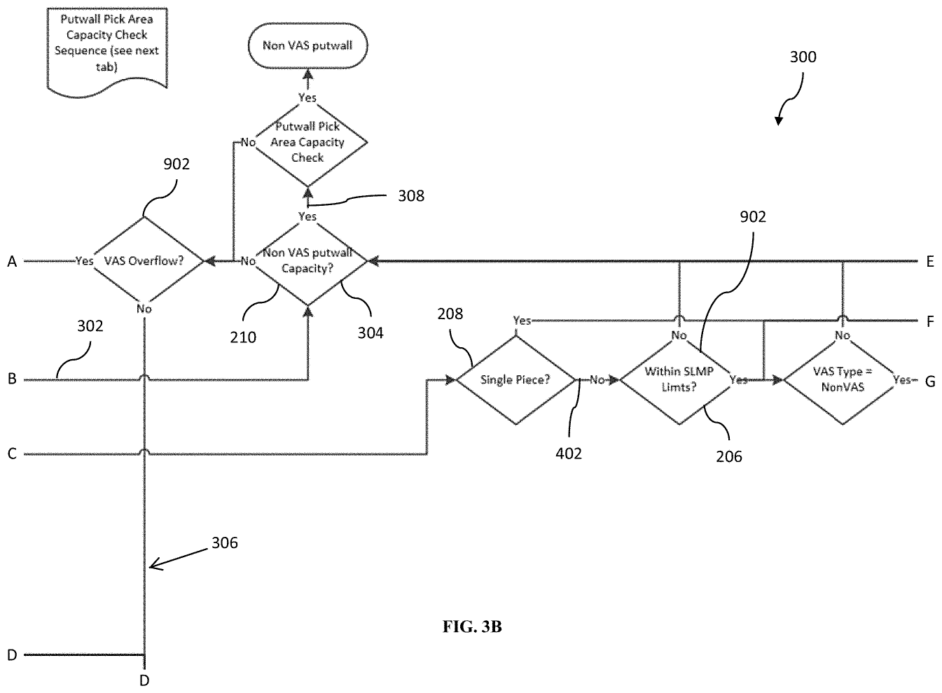

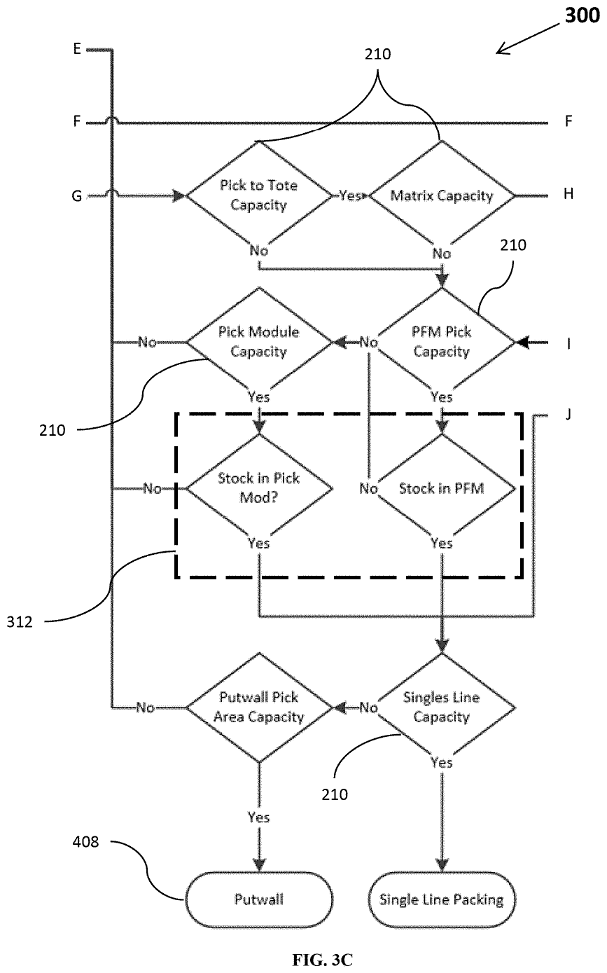

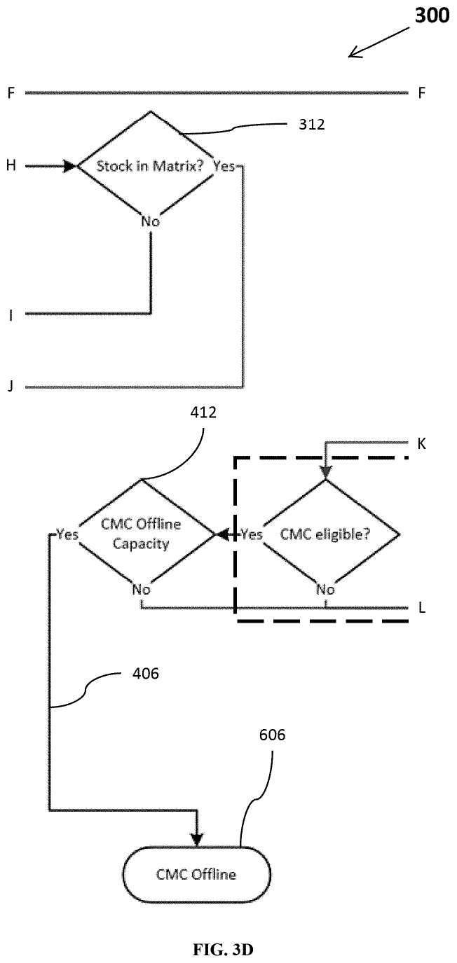

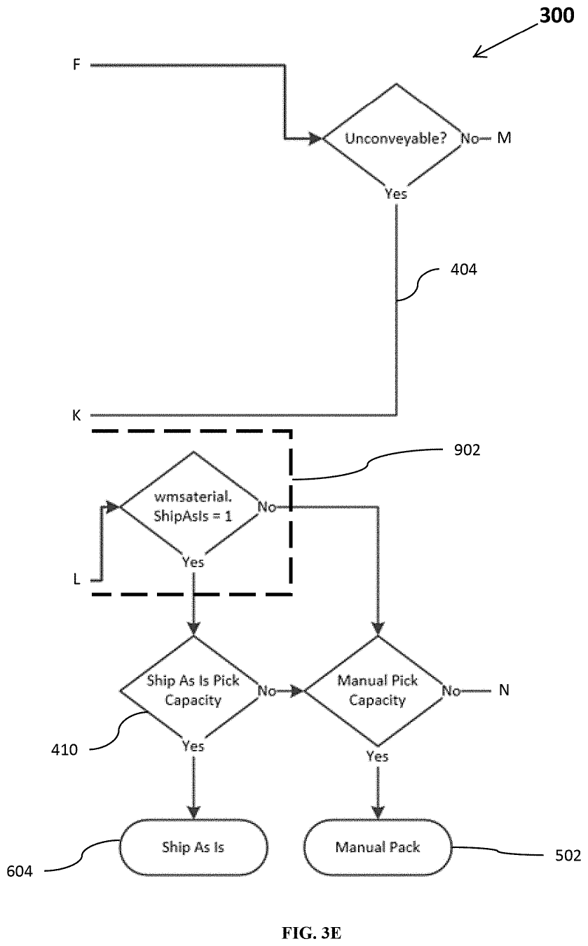

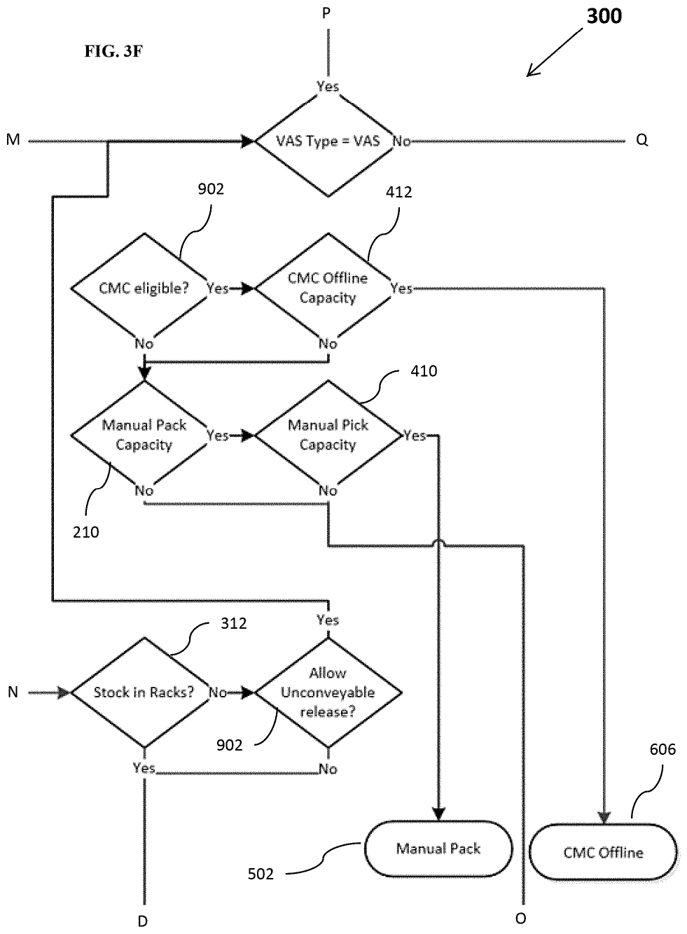

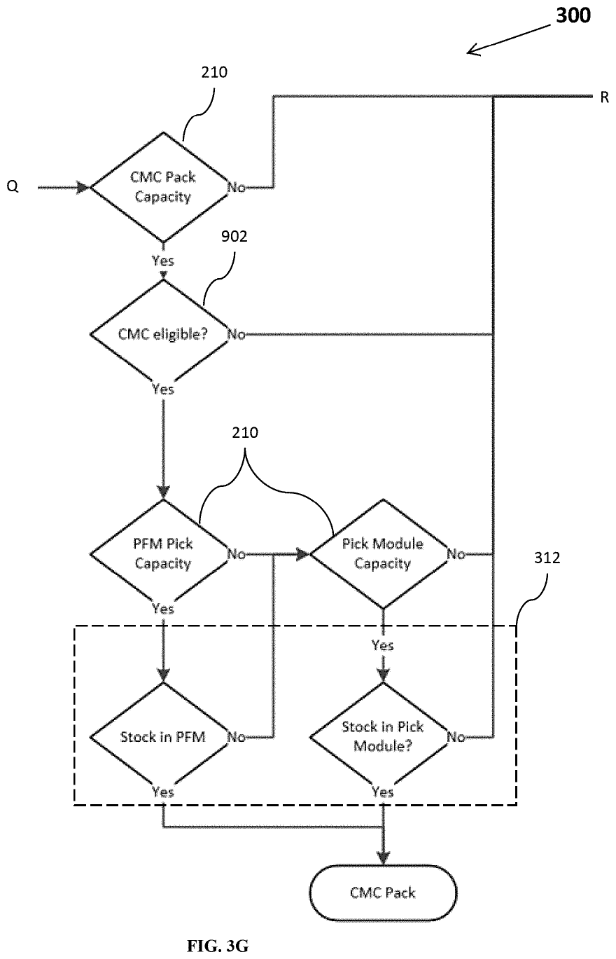

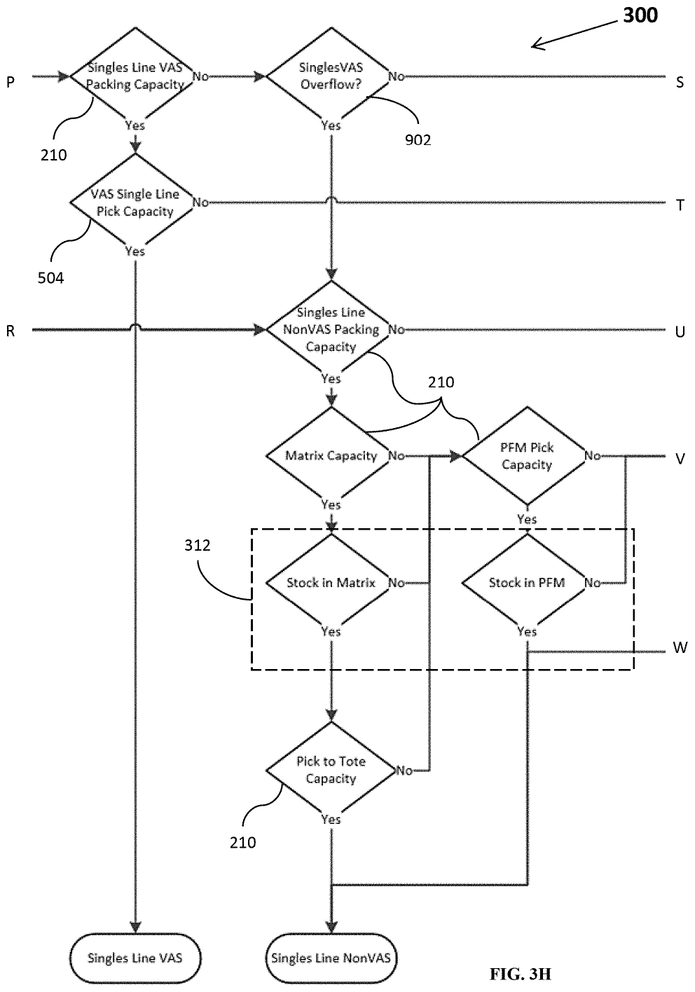

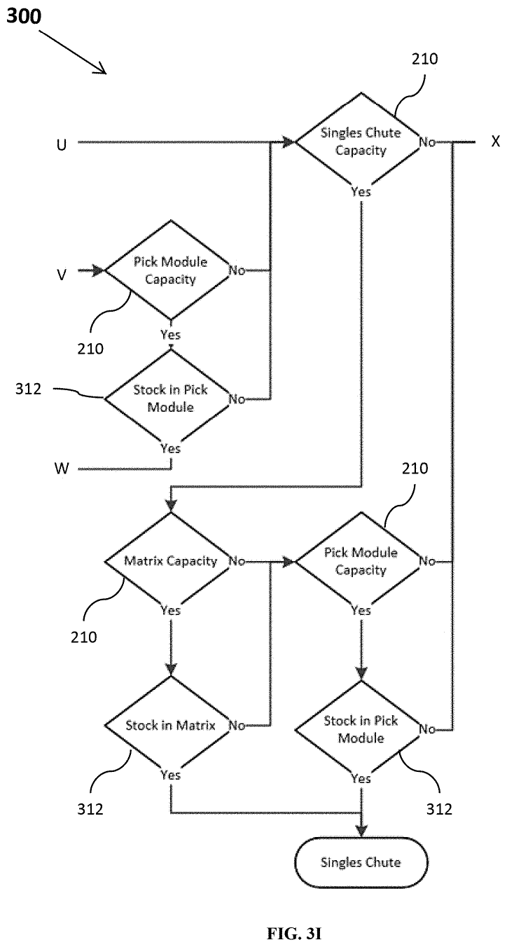

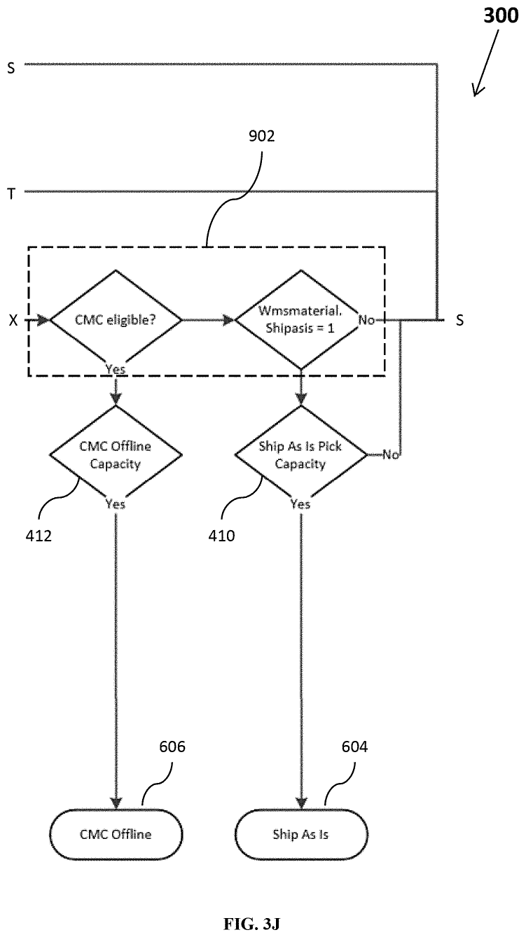

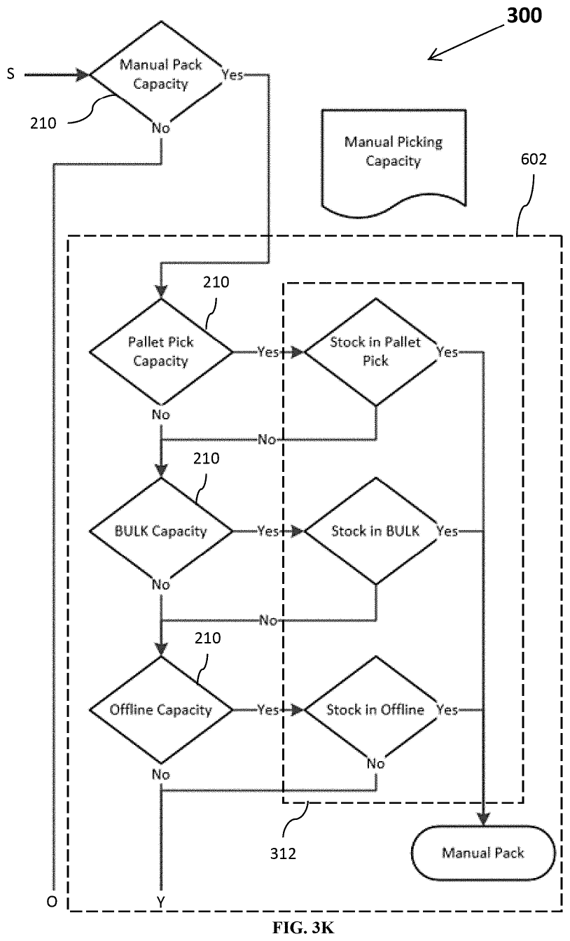

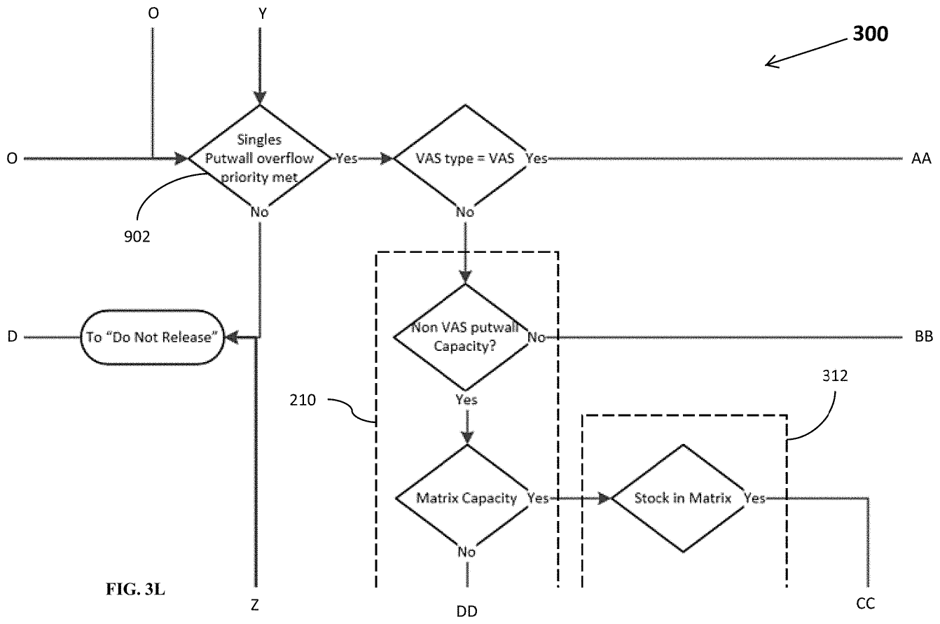

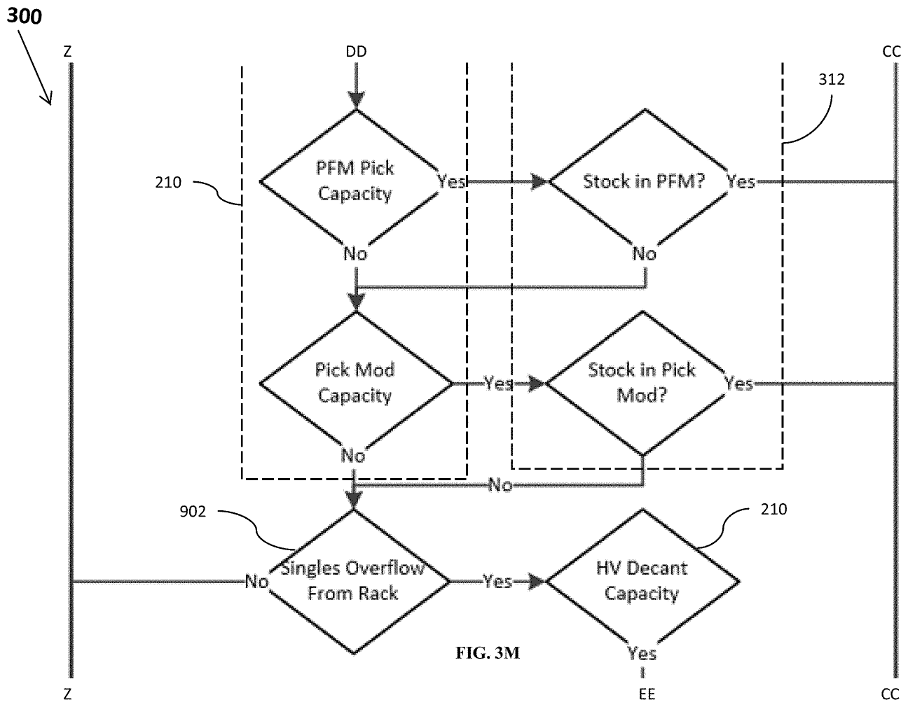

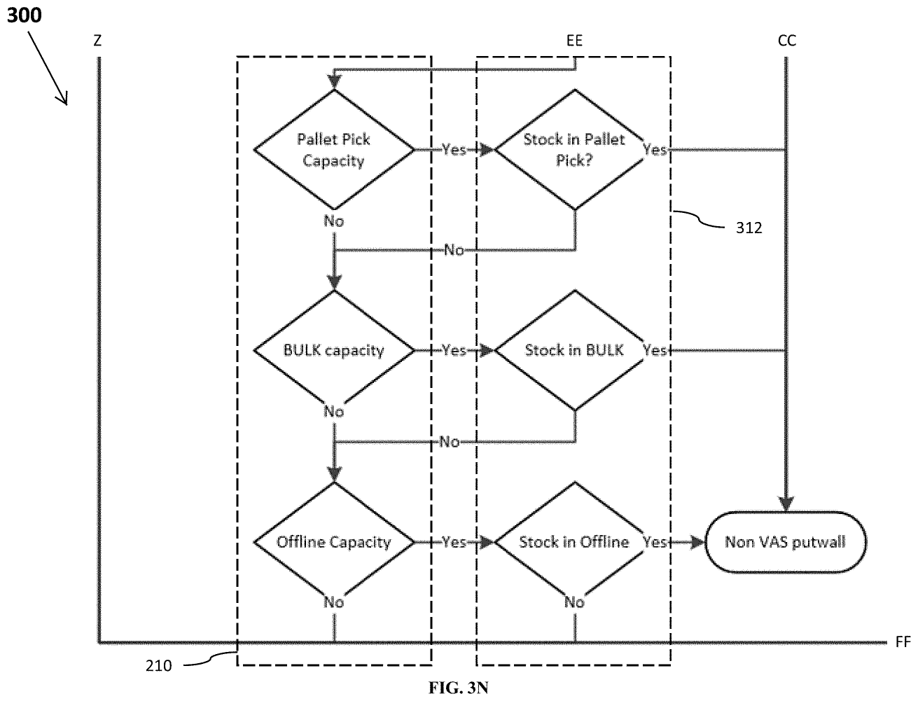

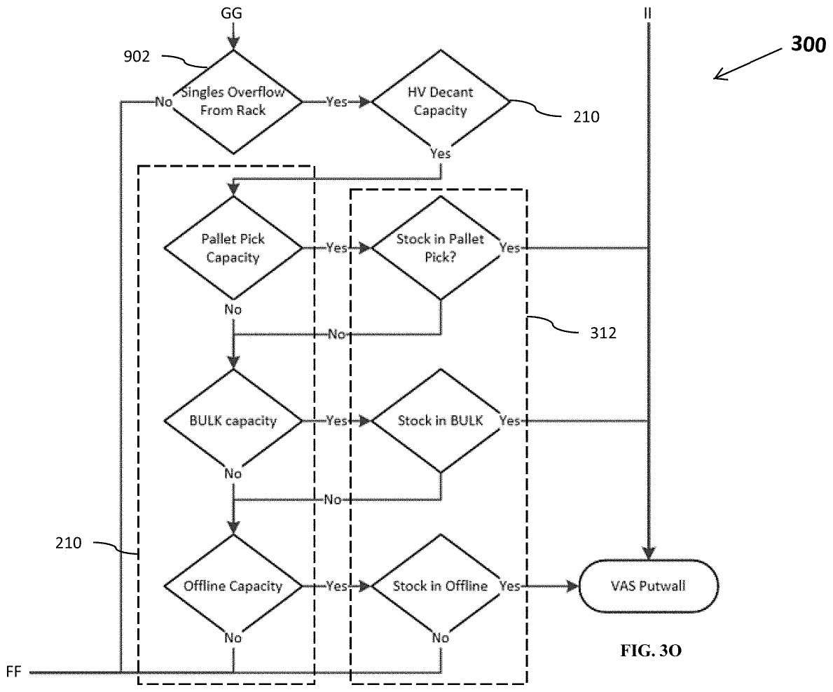

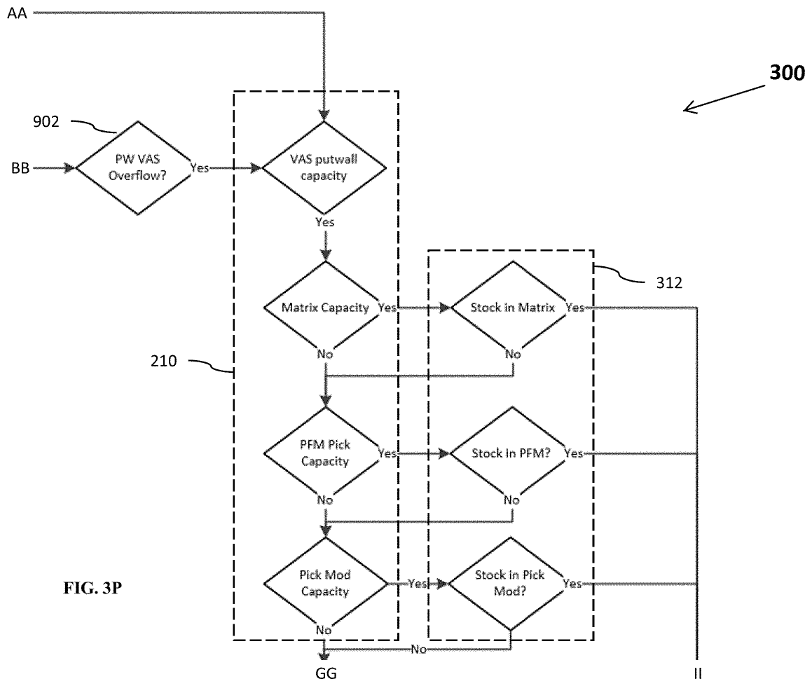

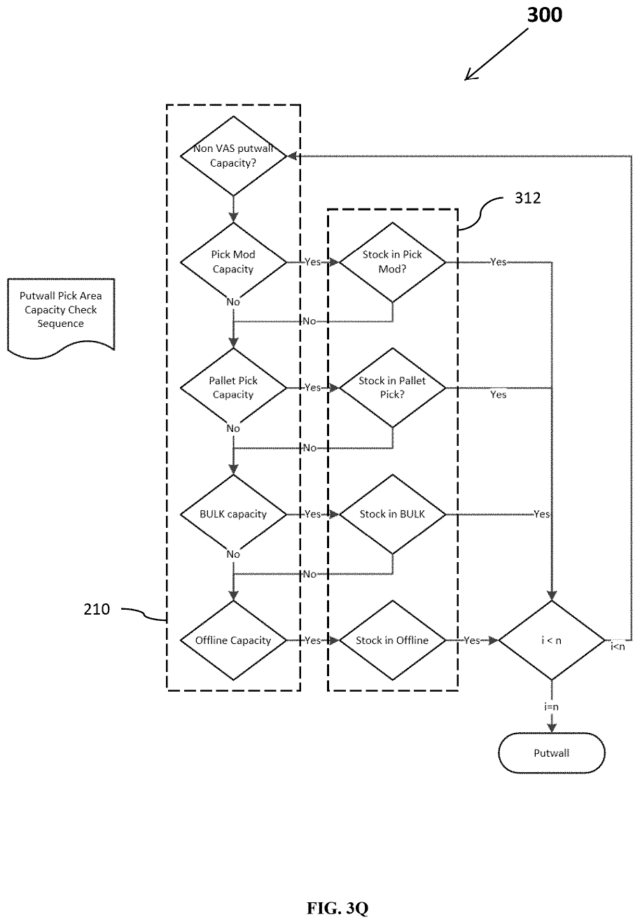

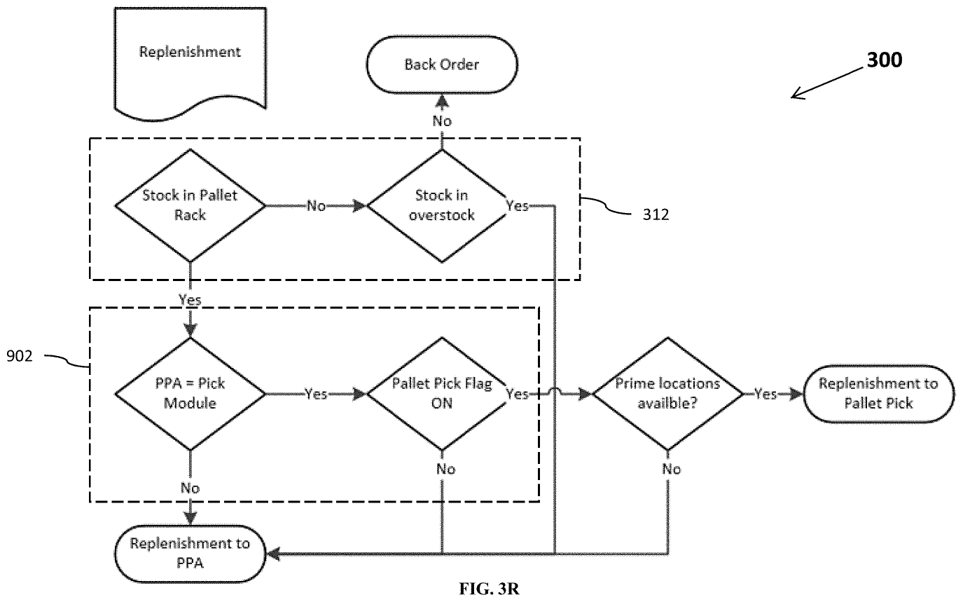

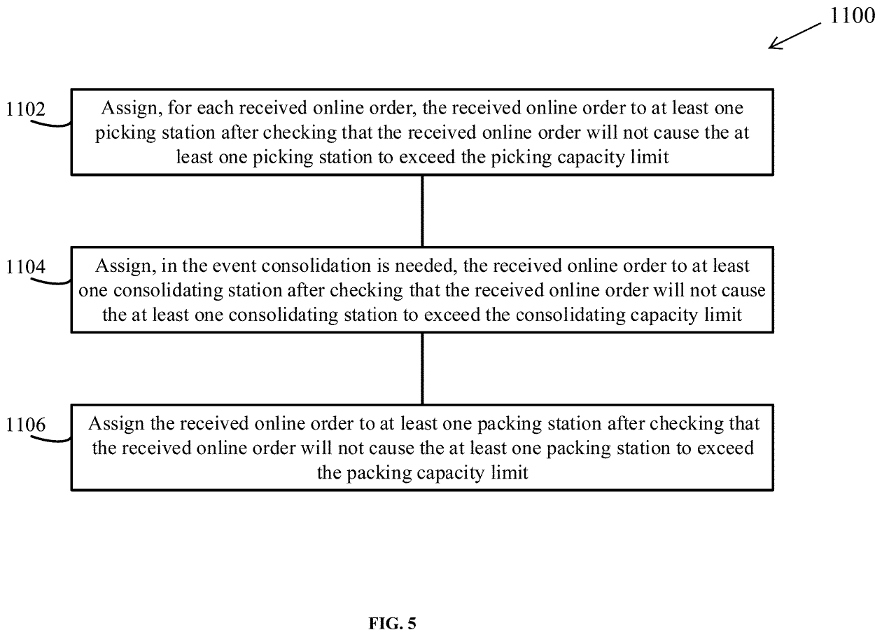

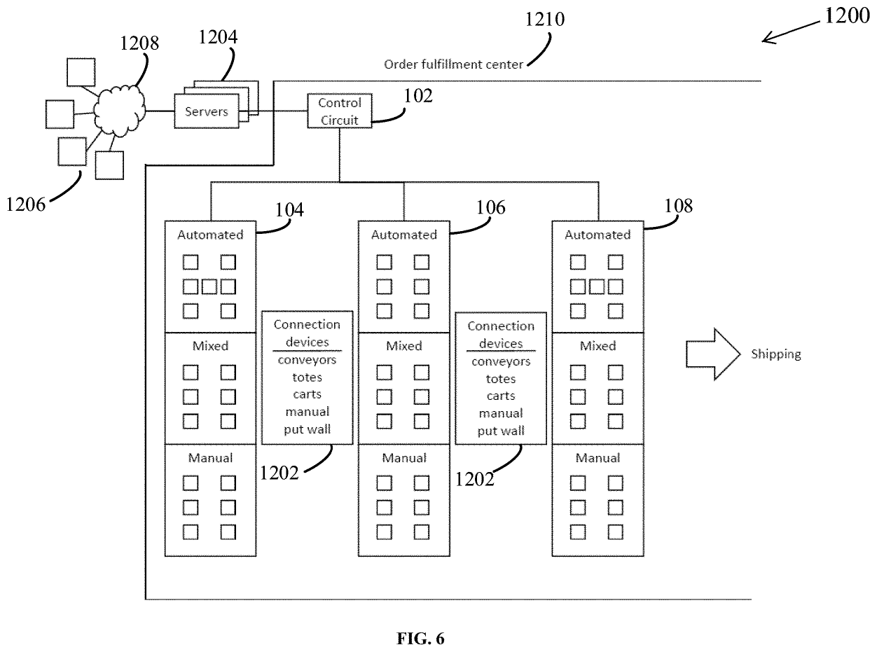

FIG. 5 shows a flow diagram of an exemplary process of processing online product orders at a fulfillment facility in accordance with some embodiments. In illustrative non-limiting examples, one or more steps in method 1100 of FIG. 5 may be implemented in one or more components of the system 100 of FIG. 1, the system 1200 of FIG. 6, or other systems. For example, the system 100 may include the plurality of picking stations 104. In one example, the plurality of picking stations 104 may include the matrix picking area, the pick module picking area, the pallet pick picking area, the bulk picking area, the offline picking area, and/or the replenishment picking area, as described in FIGS. 2A-2B and 3A-3R. By one approach, each picking station may provide a process of picking units from online orders. In one example, each of the plurality of picking stations 104 may have a picking capacity limit associated therewith. In such an example, the picking capacity limit may define a maximum number of units to be assigned to be picked by the picking station. Alternatively or in addition to, the system 100 may include the plurality of consolidating stations 106. By one approach, the plurality of consolidating stations 106 and/or the plurality of packing stations 108 may include the putwall packing area, the high velocity decant packing area, the pick-to-tote packing area, the single line packing area, the manual packing area, the CMC packing area, and/or the single chute packing area, as described in FIGS. 2A-2B and 3A-3R. In one example, each consolidating station may provide a process of consolidating multiple picked units from the online orders for packing. By one approach, each of the plurality of consolidating stations 106 may have a consolidating capacity limit associated therewith. In one configuration, the consolidating capacity limit may define a maximum number of units to be assigned to be consolidated by the consolidating station. Alternatively or in addition to, the system 100 may include the plurality of packing stations 108. By one approach, each packing station may provide a process of packing picked units and/or packing consolidated picked units into packing containers in accordance with the online orders. For example, each of the plurality of packing stations 108 may have a packing capacity limit associated therewith. In one configuration, the packing capacity limit may define a maximum number of units to be assigned to be packed by the packing station. Alternatively or in addition to, the system 100 may include the control circuit 102 coupled to the plurality of picking stations 104, the plurality of consolidating stations 106, and/or the plurality of packing stations 108. By one approach, the control circuit 102 may, for each received online order, assign the received online order to at least one picking station after checking that the received online order will not cause the at least one picking station to exceed the picking capacity limit, at step 1102. In one configuration, the control circuit 102 may assign, in the event consolidation is needed, the received online order to at least one consolidating station after checking that the received online order will not cause the at least one consolidating station to exceed the consolidating capacity limit, at step 1104. Alternatively or in addition to, the control circuit 102 may assign the received online order to at least one packing station after checking that the received online order will not cause the at least one packing station to exceed the packing capacity limit, at step 1106. In some configurations, one or more of the picking capacity limit, consolidating capacity limit and/or packing capacity limit are defined by a worker, contractor, and/or associate of the fulfillment center. Alternatively or in addition to, one or more of the picking capacity limit, consolidating capacity limit and/or packing capacity limit are adjustable and/or defined at the fulfillment center and/or particular to the fulfillment center.

In some implementations, each of the plurality of picking stations 104, the plurality of consolidating stations 106, and/or the plurality of packing stations 108 may include automated machine components to the provide the process in an automated manner. By one approach, automated machine components and a human worker may provide the process in a mixed automated and manual manner. Alternatively or in addition to, a human worker may provide the process in a manual manner. In an illustrative non-limiting example, the control circuit 102 may receive an online order associated with a plurality of units of a plurality of items. In such an example, the plurality of units of items may include 3 units and/or boxes of diapers, one unit of dishwashing liquid, two units of laundry detergents, a bag of avocados, and a 60-inch HDTV. By one approach, the control circuit 102 may identify the order type for each of the plurality of items. For example, the control circuit 102 may determine that the 3 units and/or boxes of diapers may be associated with the SLMP order 206. Alternatively or in addition to, the control circuit 102 may identify that the one unit of dishwashing liquid, two units of laundry detergents, and a bag of avocados may be associated with the ML order 204. Alternatively or in addition to, the control circuit 102 may identify that the 60-inch HDTV may be associated with the SP order 208. In some implementations, for the ML order 204, the control circuit 102 may determine that the one unit of dishwashing liquid and two units of laundry detergents may be picked from the matrix picking area. In one configuration, the control circuit 102 may determine that the bag of avocados may be picked from the pick module picking area. By one approach, after picking the units associated with the ML order 204, the control circuit 102 may allocate the picked item to the putwall packing area.

In some implementations, for the SLMP order 206, the control circuit 102 may determine that the 3 units and/or boxes of diapers may fit in a tote in the single line packing area. In response, the control circuit 102 may determine to pick the 3 units and/or boxes of diapers from the matrix picking area. Alternatively, if the control circuit 102 determines that the 3 units and/or boxes of diapers do not fit in the tote, the control circuit 102 may determine to move, re-identify, and/or reallocate the order to the ML order 204. As such, the control circuit 102 may determine to pick the 3 units and/or boxes of diapers from the pick module picking area and place them in the putwall packing area.

In some implementations, for the SP order 208, the control circuit 102 may determine that the 60-inch HDTV may be unconveyable via a conveyor system. In response, the control circuit 102 may determine that the 60-inch HDTV is unavailable to be picked from the matrix picking area and the pick module picking area. As such, the remaining pick areas available for the control circuit 102 to pick the 60-inch HDTV from are the pallet pick area, the bulk items pick area, and/or the offline pick area. By one approach, based on the control circuit's 102 access to a database storing packing areas, consolidating areas, and/or picking areas' characteristics (e.g., dimensions, quantity, and/or weight of items each area could handle, capacity limit each area could handle, to name a few), the control circuit's 102 may determine that the 60-inch HDTV is to be picked up from the bulk items picking area and packed in the manual packing area. As such, based on each of the packing areas, consolidating areas, and/or picking areas' characteristics, the control circuit's 102 may determine the optimum path and/or most efficient path to process online product orders at a fulfillment facility. Alternatively or in addition to, the control circuit 102 has the capability to mix and match packing areas, consolidating areas, and/or picking areas' characteristics to enable the most efficient and/or optimum processing of each online product order received at a fulfillment facility, thereby meeting promised delivery dates/time and/or priority assigned to the online order. For example, the control circuit 102 may assign the received online order to the at least one picking station, the at least one consolidating station, and the at least one packing station prioritizing stations by type in a priority order of stations having automated machine components, then stations having automated machine components and a human worker, then stations having a human worker.

In another illustrative non-limiting example, FIGS. 3A-3R are described below. FIGS. 3A-3R shows a flow diagram of an exemplary process/method 300 of processing online product orders at a fulfillment facility in accordance with some embodiments. By one approach, FIGS. 3A-3R is a detailed flow diagram of FIGS. 2A-2B. To assist in following the flow charts in FIGS. 2A-2B and 3A-3R, some of the elements in the flow charts are color coded. For example, orange 210 may correspond to checking for capacity, red 312 may correspond to checking for inventory, dark blue 410 may correspond to manually picking units, yellow 902 may correspond to attributes provided to the system 100 and/or the control circuit 102, brown 504 may correspond to a particular parameter (e.g., value added service (VAS)), and/or light green 412 may correspond to CMC capacity check, to name a few. In another non-limiting illustrative example, the control circuit 102 may receive another online order. By one approach, the online order may be associated with a 1,000 units of canned beans with no value added service associated to the order. In some embodiments, the following may describe the algorithm that the control circuit 102 may go through to process the online order associated with a 1,000 units of canned beans with no value added service (VAS) associated to the order. Starting with FIG. 3A, the control circuit 102 may determine that the order is an ML order 204. By one approach, the control circuit 102 may determine that the order is not associated with the VAS, at step 302 of FIG. 3B. In one configuration, the control circuit 102 may access the database to determine if the associated capacity limit for the non-VAS putwall has been reached, at step 304 of FIG. 3B Alternatively or addition to, the control circuit 102 may determine whether non-VAS putwall consolidating area and/or packing area have a capacity to accommodate staging of a 1,000 units of canned beans, at step 304 of FIG. 3B. By one approach, if the non-VAS putwall consolidating area and/or packing area does not have a capacity to accommodate staging of a 1,000 units of canned beans, the control circuit 102 may not release the order until there is a capacity in the non-VAS putwall consolidating area and/or packing area to hold and/or stage the 1,000 units of canned beans, at step 306 of FIG. 3B. By another approach, if the non-VAS putwall consolidating area and/or packing area does have a capacity, the control circuit 102 may initiate determining which picking area to pick the 1,000 units of canned beans, at step 308 of FIG. 3B.

In some embodiments, a database may store a picking area rule that the control circuit 102 may follows in determining which area to pick units from. For example, the control circuit 102 may go through the picking area rule in a particular order. In such an example, the control circuit 102 may first determine whether a capacity for a particular unit of items are available in a first picking area. By one approach, when the first picking area may not accommodate the particular unit of items requested with an online order, the control circuit 102 may then check if a second picking area has the capacity to fulfill the particular unit of items. As such, the control circuit 102 may go down through a listing of picking areas until all of the particular unit of items are fulfilled. In one configuration, the control circuit 102 may determine that the first picking area may only fulfill portions of the particular unit of items and that the remaining portions may be fulfilled by the second picking area and/or a third picking area. In some implementations, the picking area rule may include the matrix picking area, the PFM picking area, the pick module picking area, the HV decant picking area, the pallet pick picking area, the bulk picking area, and/or the offline picking area. In other implementations, the hierarchy of the picking area rule may be as previously described with the matrix picking area being the first one to check and the offline picking area being the last one to be checked. In yet some implementations, there may be a plurality of picking area rules stored in the database. By one approach, the control circuit 102 may determine which rule to follow in determining where to pick units from based on the order type as described in FIGS. 2A-2B, the consolidating area and/or packing area where the units may be consolidated and/or packed prior to being delivered, and/or a predetermined associations between each of the picking areas and a corresponding one of the plurality of picking area rules.

In another illustrative non-limiting example, the control circuit 102 may determine that the online order for a 1,000 units of canned beans with no value added service (VAS) associated to the order may be associated as an SLMP order 206. Starting with FIG. 3A, the control circuit 102 may, at step 310, determine that the order is not a ML order type. By one approach, following line C to FIG. 3B, the control circuit 102 may determine that the 1,000 units of canned beans is not an SP order 206, at step 402. In one configuration, the control circuit 102 may, at step 404 of FIG. 3E, determine that the 1,000 units of canned beans is conveyable based on the physical characteristics of the beans (e.g., weight, size, shape, etc.) and/or the conveyor system's characteristics (e.g., weight it could hold, size of items it could convey, etc.). In one configuration, the control circuit 102 may determine that a CMC machine may consolidate and/or pack the 1,000 units of canned beans and that the CMC machine has the capacity to consolidate and/or pack the 1,000 units of canned beans, at step 406 of FIG. 3D. As such, in response, the control circuit 102 may pick the 1,000 units of canned beans using a picking area rule including the pallet pick picking area, the bulk picking area, and/or the offline picking area. By one approach, the pallet pick picking area may include a plurality of units of an item and/or a plurality of items on a plurality of pallets where each pallet is placed side-by-side on a floor area. By another approach, the offline picking area may include a plurality of units of an item and/or a plurality of items on a plurality of pallets where two or more pallets are stacked vertically on top of another pallet. By yet another approach, to pick one or more units of items from the pallet pick picking area and/or the offline picking area, an associate may have to use one or more machines to move the pallet, move the boxes and/or cases of units, and/or move several units to one or more consolidating areas and/or packing areas. By yet another approach, the picking area may include a pallet flow module (PFM) picking area. In one scenario, the PFM picking area may include a plurality of units of an item and/or a plurality of items on a plurality of pallets, where each pallet may be stacked vertically on top of another pallet and/or placed side-by-side on a floor area. However, in the PFM picking area, a conveyor system transports the picked units to one or more consolidating areas and/or packing areas.

In some embodiments, a first picking area rule may include the matrix picking area, the PFM picking area, the pick module picking area, the HV decant picking area, the pallet pick picking area, the bulk picking area, and/or the offline picking area, as described in FIGS. 3L-3P. In one configuration, the first picking area rule may be associated with a putwall picking area 408 of FIG. 3C. By another approach, a second picking area rule may include the pick module picking area, the HV decant picking area, the pallet pick picking area, the bulk picking area, and/or the offline picking area, as described in FIG. 3Q. By another approach, a third picking area rule may include the pallet pick picking area, the bulk picking area, and/or the offline picking area, as shown in 602 in FIG. 3K. In one configuration, the third picking area rule may be associated with a packing area corresponding to shipping items as is 604 of FIG. 3J, CMC offline 606 of FIG. 3J, and/or manual pack 502 of FIG. 3F. In another configuration, the replenishment picking area may be associated with a method shown in FIG. 3R.

To further illustrates, FIG. 6 illustrates a simplified block diagram of an exemplary system 1200 for processing online product orders at a fulfillment facility in accordance with some embodiments. By one approach, one or more elements of the system 100 of FIG. 1 and/or one or more steps in the method 200 of FIGS. 2A-2B, the method 1100 of FIG. 5, and/or the method 300 of FIGS. 3A-3R may be implemented in the system 1200 of FIG. 6. For example, in FIG. 6, one or more customers may send online orders via one or more electronic devices 1206 (e.g., a smartphone, a computer, a smartwatch, a laptop, a tablet, etc.) to one or more retail store servers 1204 via the Internet 1208. In one configuration, the control circuit 102 of an order fulfillment center 1210 (or fulfillment facility) may receive the online orders and process each online order via one or more of the plurality of picking stations 104, the plurality of consolidating stations 106, and/or the plurality of packing stations 108. By one approach, one or more of the stations 104, 106, 108 may be coupled to each other via one or more connecting devices 1202 (e.g., putwall, totes, carts, forklift, cranes, conveyors, etc.). In one example, once an online order is picked, consolidated, and packed, the resulting packed units of item(s) are then shipped to the customer that submitted the online order. In some embodiments, once an online order is received, the control circuit 102 may prioritize the received online order relative to the other received online orders based on the order type, customer submitting the order, day and/or time order is received, promotions, customer's membership to the retail store, shipping type and/or day requirements, to name a few. In response, the control circuit 102 may select the highest priority online order relative to the remaining outstanding online order and determine whether at least one of the plurality of consolidating stations 106 and/or the plurality of packing stations 108 have the capacity to accommodate, stage, and/or pack the units of one or more items associated with the online order. By one approach, in response, the control circuit 102 may proceed to determining whether at least one of the plurality of picking stations 104 has the capacity and/or the inventory to fulfill the units of one or more items of the online order. Alternatively or in addition to, in response to the determination that the at least one of the plurality of picking stations 104 has the capacity and/or the inventory to fulfill the units of one or more items of the online order, the control circuit 102 may identify and/or provide the optimum path and/or most efficient path to process the online product order at the fulfillment facility. For example, the control circuit 102 may identify to process a particular online order as picking in the matrix picking area since the units ordered can be placed in a tote and packing in the single line packing area. Alternatively or in addition to, the control circuit 102 may identify a second processing path to process the particular online order as picking in the matrix picking area since the units ordered can be placed in a tote and packing in the putwall packing area.

In some embodiments, the system 100 may include the plurality of picking stations 104. By one approach, each picking station may provide a process of picking units from online orders. In one configuration, each of the plurality of picking stations 104 may have a picking capacity limit associated therewith. For example, the picking capacity limit may define a maximum number of units to be assigned to be picked by the picking station. By another approach, the system 100 may include the plurality of consolidating stations 106. In one configuration, each consolidating station may provide a process of consolidating multiple picked units from the online orders for packing. For example, each of the plurality of consolidating stations 106 may have a consolidating capacity limit associated therewith. In one scenario, the consolidating capacity limit may define a maximum number of units to be assigned to be consolidated by the consolidating station. By another approach, the system 100 may include the plurality of packing stations 108. In one configuration, each packing station may provide a process of packing picked units and packing consolidated picked units into packing containers in accordance with the online orders (e.g., as instructed by the customer by way of the shipping address(es), items and corresponding units ordered, expedited shipping, etc.). For example, each of the plurality of packing stations 108 may have a packing capacity limit associated therewith. In some implementations, the packing capacity limit may define a maximum number of units to be assigned to be packed by the packing station.

In some implementations, the system 100 may include the control circuit 102 coupled to the plurality of picking stations 104, the plurality of consolidating stations 106, and/or the plurality of packing stations 108. By one approach, the control circuit 102 may, for each received online order, determine a respective picking station to assign to the received online order by evaluating picking stations in priority order until a highest priority picking station that would not exceed its picking capacity limit if assigned is found. Alternatively or in addition to, the control circuit 102 may determine, in the event consolidation is needed, a respective consolidating station to assign to the received online order by evaluating consolidating stations in priority order until a highest priority consolidating station that would not exceed its consolidating capacity limit if assigned is found. Alternatively or in addition to, the control circuit 102 may determine a respective packing station to assign to the received online order by evaluating packing stations in priority order until a highest priority packing station that would not exceed its packing capacity limit if assigned is found. Alternatively or in addition to, the control circuit 102 may assign the received online order to the respective picking station, the respective consolidating station in the event consolidation is needed, and/or the respective packing station.

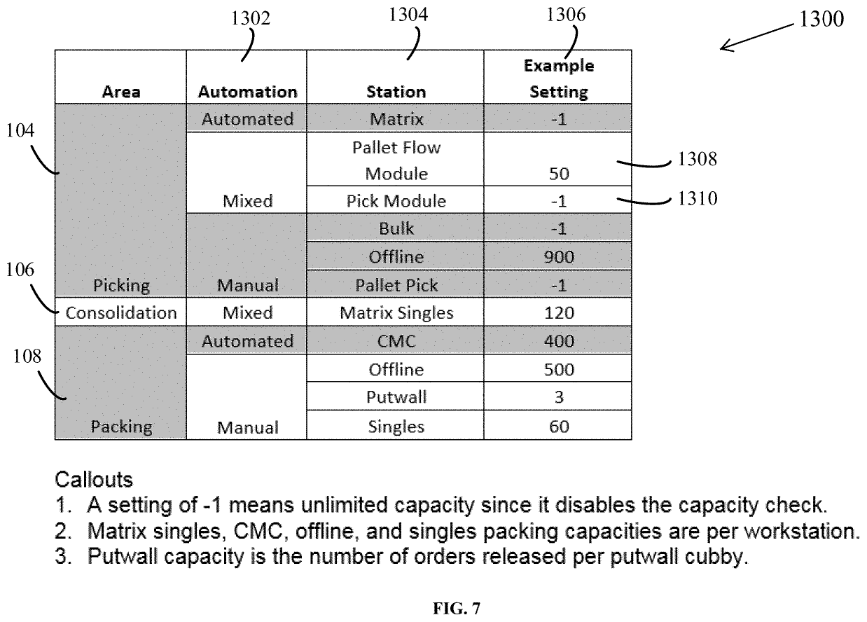

To further illustrate, FIG. 7 shows exemplary capacity limits 1300 for processing online product orders at a fulfillment facility in accordance with some embodiments. By one approach, the system 100 of FIG. 1, the system 1200 of FIG. 6, the method 1100 of FIG. 5, the method 300 of FIGS. 3A-3R, and/or the method 200 of FIGS. 2A-2B may implement one or more capacity limits shown in FIG. 7. In an illustrative non-limiting example of FIG. 7, the plurality of picking stations 104 may include a plurality of picking stations as shown in 1304. By one approach, each station may be associated with one of automation, mixed, and/or manual as shown in 1302. For example, the matrix picking area may be associated with automation. By one approach, automation may include conveyor systems, CMC machines, automated source retrieval system, and/or electronic components and/or devices that enable full and/or partial unassisted processing (e.g., picking, consolidating, and/or packing) of online orders. By another approach, manual may correspond to an associate, a contractor, and/or a worker performing the processing (e.g., picking, consolidating, and/or packing) of online orders. By yet another approach, mixed may correspond to some portions of the processing of online orders may be performed using automation while the other portions of the processing are performed by humans (e.g., an associate, a contractor, and/or a worker). In one configuration, each capacity limit in the example setting 1306 may correspond to the capacity limit and/or the maximum numbers of units to be assigned for the corresponding station 1304 and area 104.

In an illustrative non-limiting example of FIG. 7, the capacity limit of 50 at 1308 may be assigned to the pallet flow module (PFM) picking area. In such an example, a capacity limit of 50 may be assigned by the control circuit 102 to the picking area at a first time. By one approach, after a period of time (e.g., one or more combinations of a predefined number of seconds, minutes, hours, and/or day), the control circuit 102 may, at a second time, check and/or determine how many units out of the 50 that has been completed and/or picked. After determining the number units completed and/or picked, the control circuit 102 may assign additional units to pick to the PFM picking area, where the additional units are the same value as the number of units that had been completed/picked by the PFM picking area at the second time. As such, at a third time, the control circuit 102 may determine that all units assigned to be processed at the PFM picking area has been completed and/or picked. In response, the control circuit 102 may assign 50 units to be processed at the PFM picking area at the third time. Thus, the control circuit 102 may at any given time process a number of units in accordance with the respective capacity limit assigned to that particular area/station. In some implementation, the capacity limit may be based on a predefined value, time of day, work shift (e.g., night, day, etc.), months, season (e.g., winter, summer, etc.), holidays (e.g., Black Friday, Memorial Day, etc.), promotions, planned forecast, staffing, historical data of stations and/or resources throughput, to name a few. In one configuration, each corresponding capacity limit for a picking area, a consolidation area, and/or a packing area may be provided to the control circuit 102 by an associate, a contractor, a worker and/or via a capacity limit table stored in a database accessible by the control circuit 102. By one approach, the control circuit 102 may automatically update each corresponding capacity limit based on a forecast data and/or historical data. In some implementations, one or more stations 1304 may have a corresponding capacity limit that is set to −1 corresponding to unlimited capacity, as shown at 1310. In such an implementation, a capacity limit of −1 and/or unlimited may correspond to the particular station not having a fixed number of capacity. As such, the station may be assigned a number of units to pick, consolidate, and/or pack as assigned by the control circuit 102 at any given time.

Those skilled in the art will recognize that a wide variety of other modifications, alterations, and combinations of capacity limits may be assigned to each station, area, or combination thereof with respect to the above described embodiments without departing from the scope of the invention, and that such modifications, alterations, and combinations are to be viewed as being within the ambit of the inventive concept.

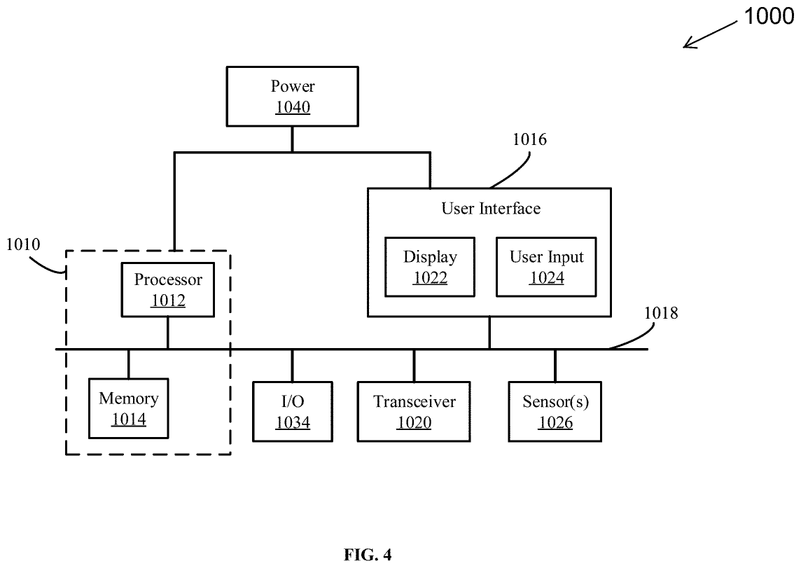

Further, the circuits, circuitry, systems, devices, processes, methods, techniques, functionality, services, servers, sources and the like described herein may be utilized, implemented and/or run on many different types of devices and/or systems. FIG. 4 illustrates an exemplary system 1000 that may be used for implementing any of the components, circuits, circuitry, systems, functionality, apparatuses, processes, or devices of the system 100 of FIG. 1, the method 200 of FIGS. 2A-2B, the method 300 of FIGS. 3A-3R, the method 1100 of FIG. 5, the system 1200 of FIG. 6, and/or other above or below mentioned systems or devices, or parts of such circuits, circuitry, functionality, systems, apparatuses, processes, or devices. For example, the system 1000 may be used to implement some or all of the system for processing online product orders at a fulfillment facility, the control circuit 102, the conveyor system, the database, the automated source retrieval system, the electronic device 1206, the Internet 1208, the servers 1204, and/or other such components, circuitry, functionality and/or devices. However, the use of the system 1000 or any portion thereof is certainly not required.

By way of example, the system 1000 may comprise a processor module (or a control circuit) 1012, memory 1014, and one or more communication links, paths, buses or the like 1018. Some embodiments may include one or more user interfaces 1016, and/or one or more internal and/or external power sources or supplies 1040. The control circuit 1012 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 1012 can be part of control circuitry and/or a control system 1010, which may be implemented through one or more processors with access to one or more memory 1014 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 1000 may be used to implement one or more of the above or below, or parts of, components, circuits, systems, processes and the like. For example, the system 1000 may implement the system for processing online product orders at a fulfillment facility with the control circuit 102 being the control circuit 1012.

The user interface 1016 can allow a user to interact with the system 1000 and receive information through the system. In some instances, the user interface 1016 includes a display 1022 and/or one or more user inputs 1024, such as buttons, touch screen, track ball, keyboard, mouse, etc., which can be part of or wired or wirelessly coupled with the system 1000. Typically, the system 1000 further includes one or more communication interfaces, ports, transceivers 1020 and the like allowing the system 1000 to communicate over a communication bus, a distributed computer and/or communication network (e.g., a local area network (LAN), the Internet, wide area network (WAN), etc.), communication link 1018, other networks or communication channels with other devices and/or other such communications or combination of two or more of such communication methods. Further the transceiver 1020 can be configured for wired, wireless, optical, fiber optical cable, satellite, or other such communication configurations or combinations of two or more of such communications. Some embodiments include one or more input/output (I/O) interface 1034 that allow one or more devices to couple with the system 1000. The I/O interface can be substantially any relevant port or combinations of ports, such as but not limited to USB, Ethernet, or other such ports. The I/O interface 1034 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 1026 to provide information to the system and/or sensor information that is communicated to another component, such as the control circuit 102, the conveyor system, the database, the automated source retrieval system, the electronic device 1206, the Internet 1208, the servers 1204, etc. The sensors can include substantially any relevant sensor, such as temperature sensors, distance measurement sensors (e.g., optical units, sound/ultrasound units, etc.), optical based scanning sensors to sense and read optical patterns (e.g., bar codes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 1000 comprises an example of a control and/or processor-based system with the control circuit 1012. Again, the control circuit 1012 can be implemented through one or more processors, controllers, central processing units, logic, software and the like. Further, in some implementations the control circuit 1012 may provide multiprocessor functionality.

The memory 1014, which can be accessed by the control circuit 1012, typically includes one or more processor readable and/or computer readable media accessed by at least the control circuit 1012, and can include volatile and/or nonvolatile media, such as RAM, ROM, EEPROM, flash memory and/or other memory technology. Further, the memory 1014 is shown as internal to the control system 1010; however, the memory 1014 can be internal, external or a combination of internal and external memory. Similarly, some or all of the memory 1014 can be internal, external or a combination of internal and external memory of the control circuit 1012. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network. The memory 1014 can store code, software, executables, scripts, data, content, lists, programming, programs, log or history data, user information, customer information, product information, and the like. While FIG. 4 illustrates the various components being coupled together via a bus, it is understood that the various components may actually be coupled to the control circuit and/or one or more other components directly.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for processing online product orders at a fulfillment facility, the system comprising:
a plurality of picking stations each configured to provide a process of picking units from online orders, wherein each of the plurality of picking stations has a picking capacity limit associated therewith, the picking capacity limit defining a maximum number of units to be assigned to be picked by the picking station;
a plurality of consolidating stations each configured to provide a process of consolidating multiple picked units from the online orders for packing, wherein each of the plurality of consolidating stations has a consolidating capacity limit associated therewith, the consolidating capacity limit defining a maximum number of units to be assigned to be consolidated by the consolidating station;
a plurality of packing stations each configured to provide a process of packing picked units and packing consolidated picked units into packing containers in accordance with the online orders, wherein each of the plurality of packing stations has a packing capacity limit associated therewith, the packing capacity limit defining a maximum number of units to be assigned to be packed by the packing station; and
a control circuit coupled to the plurality of picking stations, the plurality of consolidating stations, and the plurality of packing stations, wherein the control circuit is configured to:
for each received online order,
assign the received online order to at least one picking station after checking that the received online order will not cause the at least one picking station to exceed the picking capacity limit;
assign, in the event consolidation is needed, the received online order to at least one consolidating station after checking that the received online order will not cause the at least one consolidating station to exceed the consolidating capacity limit; and
assign the received online order to at least one packing station after checking that the received online order will not cause the at least one packing station to exceed the packing capacity limit.

2. The system of claim 1, wherein each of the plurality of picking stations, the plurality of consolidating stations and the plurality of packing stations include:
automated machine components to the provide the process in an automated manner;
automated machine components and a human worker to the provide the process in a mixed automated and manual manner; and
a human worker to the provide the process in a manual manner.

3. The system of claim 2, wherein the control circuit is configured to assign the received online order to the at least one picking station, the at least one consolidating station, and the at least one packing station prioritizing stations by type in a priority order of stations having automated machine components, then stations having automated machine components and a human worker, then stations having a human worker.

4. The system of claim 1, wherein the system comprising:
conveyors configured to convey units between one or more of the plurality of picking stations, one or more of the consolidating stations, and one or more of the packing stations.

5. The system of claim 1, further comprising a consolidating storage area comprising a shelf for staging multiple picked units for the online orders until all units associated with given online orders are picked and staged in the consolidating storage area.

6. The system of claim 1, further comprising an automated source retrieval system comprising one or more robots configured to pick units from at least one of the plurality of picking stations and place the picked units on at least one of a conveyor, cart and a tote to hold the picked units in place while being transported to at least one of the plurality of consolidating stations and the plurality of packing stations.

7. The system of claim 1, wherein one or more of the picking capacity limit, consolidating capacity limit and packing capacity limit are defined by a worker of the fulfillment center.

8. The system of claim 1, wherein one or more of the picking capacity limit, consolidating capacity limit and packing capacity limit are adjustable and defined at the fulfillment center.

9. A system for processing online product orders at a fulfillment facility, the system comprising:
a plurality of picking stations each configured to provide a process of picking units from online orders, wherein each of the plurality of picking stations has a picking capacity limit associated therewith, the picking capacity limit defining a maximum number of units to be assigned to be picked by the picking station;
a plurality of consolidating stations each configured to provide a process of consolidating multiple picked units from the online orders for packing, wherein each of the plurality of consolidating stations has a consolidating capacity limit associated therewith, the consolidating capacity limit defining a maximum number of units to be assigned to be consolidated by the consolidating station;
a plurality of packing stations each configured to provide a process of packing picked units and packing consolidated picked units into packing containers in accordance with the online orders, wherein each of the plurality of packing stations has a packing capacity limit associated therewith, the packing capacity limit defining a maximum number of units to be assigned to be packed by the packing station; and
a control circuit coupled to the plurality of picking stations, the plurality of consolidating stations, and the plurality of packing stations, wherein the control circuit is configured to:
for each received online order,
determine a respective picking station to assign to the received online order by evaluating picking stations in priority order until a highest priority picking station that would not exceed its picking capacity limit if assigned is found;
determine, in the event consolidation is needed, a respective consolidating station to assign to the received online order by evaluating consolidating stations in priority order until a highest priority consolidating station that would not exceed its consolidating capacity limit if assigned is found;
determine a respective packing station to assign to the received online order by evaluating packing stations in priority order until a highest priority packing station that would not exceed its packing capacity limit if assigned is found; and
assign the received online order to the respective picking station, the respective consolidating station in the event consolidation is needed, and the respective packing station.

10. The system of claim 9, wherein a priority order used when the control circuit determines the respective picking station, the respective consolidating station, and the respective packing station is by station type in the order of stations having automated machine components, then stations having automated machine components and a human worker, then stations having a human worker.
